(19) United States
(12) Patent Application Publication
(10) Pub. No.: US 2001/0007128 A1
(43) Pub. Date: Jul. 5, 2001

(54) Security mechanism providing access control for locally-held data

(75) Inventors: Howard Shelton Lambert, Hedge End (GB); James Ronald Orchard, Winchester (GB)

Correspondence Address: Blanche E. Schiller, Esq., HESLIN & ROTHENBERG, P.C., 5 Columbia Circle, Albany, NY, 12203, US

(73) Assignee: International Business Machines Corporation, Armonk, NY (US)

(21) Appl. No.: 09/745,863

(22) Filed: Dec. 21, 2000

(30) Foreign Application Priority Data
Dec. 22, 1999 (GB) 9930793.6

(51) Int. Cl. H04L 12/22; H04L 9/32

(52) U.S. Cl. 713/165; 713/201

(57) ABSTRACT

Methods and data processing apparatuses are provided which enable controlling, from one data processing apparatus, access to data held (for example on a queue) at another data processing apparatus. When a requester wishes to access data held at a local data processing apparatus, a request must be sent to a remote data processing apparatus to determine the security attributes of the data (for example, retrieving queue attributes from a database). The requestor cannot access the data until the security attributes are fully determined at the local data processing apparatus, and since communication with a remote system is required to make this determination the remote apparatus is able to log the requests for data access. The security attributes are preferably an identifier of a cryptor used in compression, a compressor used in compression and an authenticator for authenticating the requestor. The determination of security attributes is preferably required to be repeated for each requester session, with the attributes being deleted from the local data processing apparatus at the end of a session and the requestor being unable to view or save the attributes. This enables session-specific access control.

### PRIOR FOREIGN APPLICATION

This application claims priority from British patent application number 9930793.6, filed Dec. 22, 1999, which is hereby incorporated herein by reference in its entirety.

### TECHNICAL FIELD

The present invention relates to controlling access to data held on a data processing apparatus, for improved security or auditing.

### BACKGROUND ART

Many solutions are known in which a server computer implements security mechanisms for controlling access to data held on the server computer, with the data only being distributed to requesting client data processing devices if the security controls are satisfied. This access control can be as simple as comparing the ID of the requesting user or device with a list of access authorities held on the server, or may involve checking passwords, or various schemes using cryptographic algorithms. One example using cryptography involves the data being held on the server in an encrypted form and, when a remote user requests the data, an identification and authentication of the requester is performed on the server and only then is the data sent to the requestor via a secure communication channel.

Additionally, data is often distributed to client devices in an encrypted or other protected form, such that the data is not readable during transmission to the client and is only readable on the client device after decoding keys such as decryption keys are used to decode the data at the client device. Thus, security mechanisms are known to be used for protecting data while it is being sent between data processing systems within a network. This use of cryptography for secure communication is a very common use of cryptographic techniques, since it is generally accepted that data is most exposed to attack by eavesdroppers (intercepting the data, and either copying or modifying it) while it is being sent across a network.

Secure Sockets Layer (SSL) is a security protocol developed by Netscape Communications Corporation for providing data security and privacy over the Internet. The SSL protocol supports server and client authentication and is application dependent, allowing protocols such as HTTP, Telnet, NNTP, or FTP to be layered on top of it transparently. SSL is based on public key cryptography and is used in the negotiation of encryption keys as well as to authenticate the server before data is exchanged with an application. SSL maintains the security and integrity of a transmission channel by using encryption, authentication and message authentication codes.

Standard Java(TM) enabled Web Servers provide for Secure Sockets Layer (SSL) to encrypt data flows between a Web server and a compatible Web browser. However, there are a number of problems with SSL, stemming from the fact that there can only be one level of encryption for all types of data:

data is decrypted, and hence held in an unprotected form, within the server and browser;

data transmitted between the Web browser and Web server is either encrypted according to SSL or clear—there is no intermediate protocol; and

data is not compressed.

GB-A-2337671 (IBM docket reference UK998045) mitigates these problems by defining a mechanism whereby Servlets run within the context of a secure session which has predefined levels of security, encryption and compression. Although providing advantages in this context, nevertheless GB-A-2337671 is an example of the conventional situation of security attributes being defined between communication partners and the communication partners then having full control over access to data communicated between them.

Cryptographic schemes are also known to be usable for protecting access to data or applications on a local data processing system—i.e. for local identification and authentication. An example is described in GB-A-2329499 (IBM docket reference UK997052), in which an operator of a retail till may be required to enter their password and to insert a smartcard into the till before applications running on the till will be operable. The smartcard holds a first partial decryption key and the password comprises a second partial key, and together they generate a decryption key enabling specific decrypted applications to be executed or enabling encrypted data to be read.

GB-A-2329499 is an example of the typical situation in which a trusted user wishing to access the local data or service has control over the relevant decoder key or a partial key. This feature of the requester controlling the key is also typically true with secure remote communications examples in which decryption capabilities (either the functional code or keys or both) are transmitted to a receiver device together with encrypted data to enable the data to be decrypted on receipt.

### SUMMARY OF THE INVENTION

In a first aspect, the present invention provides a method of controlling access to data, comprising: in response to a request from a requester for access to data stored in an encoded form on a first data processing apparatus, sending a request from a decoding controller on the first data processing apparatus to a second data processing apparatus to determine attributes of a decoding process for accessing the encoded data; in response to said request to the second data processing apparatus, receiving said determined attributes at said decoding controller; performing the decoding process in accordance with the determined attributes.

Since a request to the second data processing apparatus is required to determine attributes of the decoding process, the second data processing apparatus has a degree of control over the access to data stored on the first data processing apparatus (e.g. in volatile memory or in non-volatile disk storage). The second data processing apparatus can therefore log data access operations for auditing purposes and can be used to implement additional security mechanisms.

Control by a remote system over access to locally stored data is different from conventional data access control methods, which typically use only locally-implemented access controls in relation to locally stored data. In conventional methods, if encryption is used to protect data during network communication, then the decryption process is typically fully defined at the local data processing apparatus when the data has been delivered.

It should be noted that the invention does not require a one-to-one relationship between a user's data access request and a request being sent to the second data processing apparatus. It may be that the communication with the second data processing apparatus only occurs when a user wishes to access data which has a security level above a threshold, or data which has a security classification which is different from the currently authorised security classification. The decoding controller preferably determines when to send requests to the second data processing apparatus to determine decoding attributes, and this could involve one request to the second data processing apparatus for many user or application requests, or many requests to the second data processing apparatus for one user or application request.

The decoding attributes are preferably kept inaccessible (shielded) from the requestor, even when received by the decoding controller and stored in volatile memory on the first data processing apparatus, in the sense that the requester cannot read or save any details about the attributes. The requestor thus makes use of the decoding process, and hence makes use of the process's attributes, but never has direct access to or control of the attributes. This is different from conventional use of decryption, authentication and decompression where the requester has direct access to the respective cryptor, authenticator and compressor components. The “requester” in this context may be an application program or a person.

Preferably, the attributes of the decoding process are only determined in response to a request from a specific requester for access to a specific stored data block or queue, they are only determined for that specific request and are never transferred to non-volatile storage of the first data processing system but are only ever held in volatile memory, and no details of the attributes are visible to or retained by the requestor. In particular, requestor application programs are given no mechanism for accessing attributes and attributes are deleted from volatile main memory at the end of each requestor session. This means that the attribute determination is specific to the current requester session and so, according to this embodiment of the invention, the request to the second data processing apparatus has to be repeated for subsequent requester sessions which require access to the same data or to other data of the same security level. This facilitates maintenance of a log of data accesses by the second data processing apparatus and also facilitates provision of per-session security control.

Requestor authentication may be implemented as a step separate from the decoding process, with decoding only being performed after successful authentication of the requestor, or as a step of the decoding process. The decoding preferably includes decryption of encrypted data stored on the first data processing apparatus.

In a preferred embodiment of the invention, the attributes of the decoding process include identifiers of: a cryptor used in encryption and required for decryption, if any; a compressor used in compression and required for decompression, if any; and an authenticator for requestor authentication. After determining these identifiers of processing components, the decoding controller is able to initiate execution of decoding processing if program code implementing the processing components is available on the local apparatus. The decoding controller preferably checks whether the identified code is locally available and, if not, initiates downloading of the code from the second data processing apparatus in a secure way (for example, encrypted or digitally signed).

Alternatively, the attributes obtained from a second data processing apparatus may additionally or alternatively include the program code implementing the decoding (such as a cryptor algorithm, compressor algorithm, and authenticator algorithm, or other processing components). The attributes may additionally or alternatively include one or more decryption keys or authentication keys.

A security mechanism implementing the invention according to one embodiment requires a user of the first data processing apparatus to enter a personal identification and password, and/or one or more decoding keys or partial keys, for use in user-authentication. The mechanism may require entry of a plurality of partial keys which are each held by different people, such as if a financial advisor holds a first partial key and each of his customers holds a second partial key and both are required to establish a session in which confidential data relevant to a customer is accessible. Thus, a network communication is required to perform decoding, such that remote logging of data accesses is possible, and the customer has control over either the network communication itself or the subsequent decoding process. This example demonstrates that the invention can be used to control access to locally stored data such that, if access is only enabled for the current session and the customer must be present to authorize the session, a customer can be confident that the confidentiality of their data will be protected even when the data is stored on a computer owned by their supplier or financial advisor. Remote logging of local data access requests and auditing provide subsequent confirmation.

The invention has an additional advantage of avoiding the need for complicated data partitioning on a first data processing apparatus (which may be a PDA or other small computing device with only limited memory resources). Since the data access mechanism of the invention can be used to achieve independent access to different data items even if stored in a common data block, data for which different access rights exist can be stored in a common data block or queue without requiring secure partitions to be part of the data storage structure.

In a second aspect, the invention provides a first data processing apparatus including: a processing unit; data storage means; communication means for sending and receiving communications from data processing systems connectable to said first data processing apparatus via a network; and a decoding controller, responsive to a request from a requester for access to data stored in an encoded form in said data storage means, for sending a request via said communication means to a second data processing apparatus to determine attributes of a decoding process for accessing the encoded data and for receiving said determined attributes via said communication means; wherein the decoding controller is adapted to control the operation of the processing unit to perform the decoding process in accordance with the determined attributes.

According to a preferred embodiment of the invention, the second data processing apparatus referred to above has the following components when used to implement the invention: a processing unit; data storage means storing attributes of one or more decoding processes, which processes are associated with specific data stored in an encoded form on the first data processing apparatus; and an access controller component, for retrieving the stored attributes from the data storage means in response to a request from the decoding controller on the first data processing apparatus, and for sending the retrieved attributes to the decoding controller.

The attributes may be held in a queue definitions database which is either centrally maintained or is distributed within a network so as to be accessible from all data processing systems which are running a decoding controller as described above.

In an embodiment of the invention in which the data on the first data processing apparatus has been sent across the network from a third data processing apparatus, the third data processing apparatus includes an encoding controller capable of obtaining the attributes from the second data processing apparatus and using the attributes to encode the data before sending it across the network to the first data processing apparatus.

In a third aspect, the invention provides a computer program implementing functions for controlling the operation of a data processing apparatus on which the program runs to perform the following steps of a method for controlling access to encoded data: in response to a request from a requester for access to data stored in an encoded form on a first data processing apparatus, sending a request from a decoding controller on the first data processing apparatus to a second data processing apparatus to determine attributes of a decoding process for accessing the encoded data; in response to said request to the second data processing apparatus, receiving said determined attributes at said decoding controller; performing the decoding process in accordance with the determined attributes.

The invention may be implemented as a program product comprising a computer readable recording medium having computer readable program code recorded thereon, the program code implementing functions for controlling the operation of a data processing apparatus on which the program code runs to perform the steps of a method as described above. Each of the decoding controller and access controller components may be implemented in separate computer program products for running on different data processing apparatuses to provide improved control of access to encoded stored data.

### BRIEF DESCRIPTION OF THE DRAWINGS

Preferred embodiments of the present invention will now be described in more detail, by way of example, with reference to the accompanying drawings in which:

FIG. 1 is a schematic representation of a network of data processing systems, in which the present invention may be implemented; and

FIG. 2 shows the steps of a method of access control according to an embodiment of the invention.

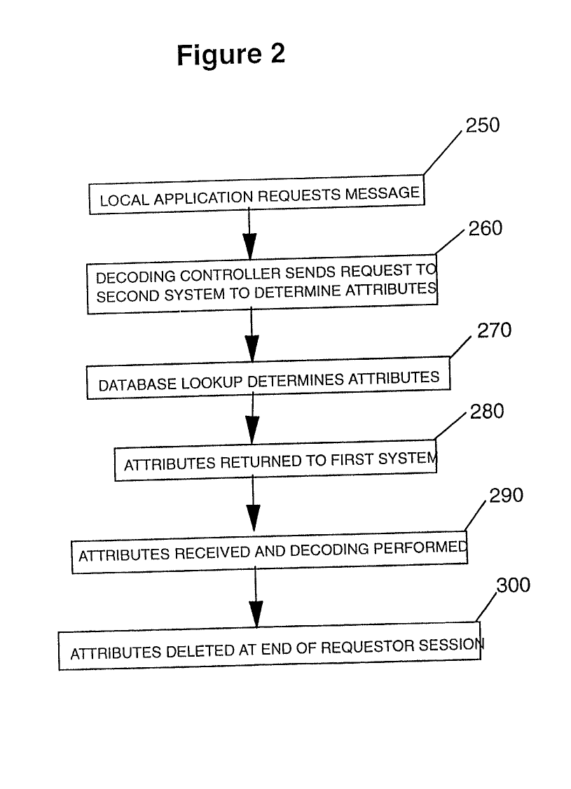

### BEST MODE FOR CARRYING OUT THE INVENTION

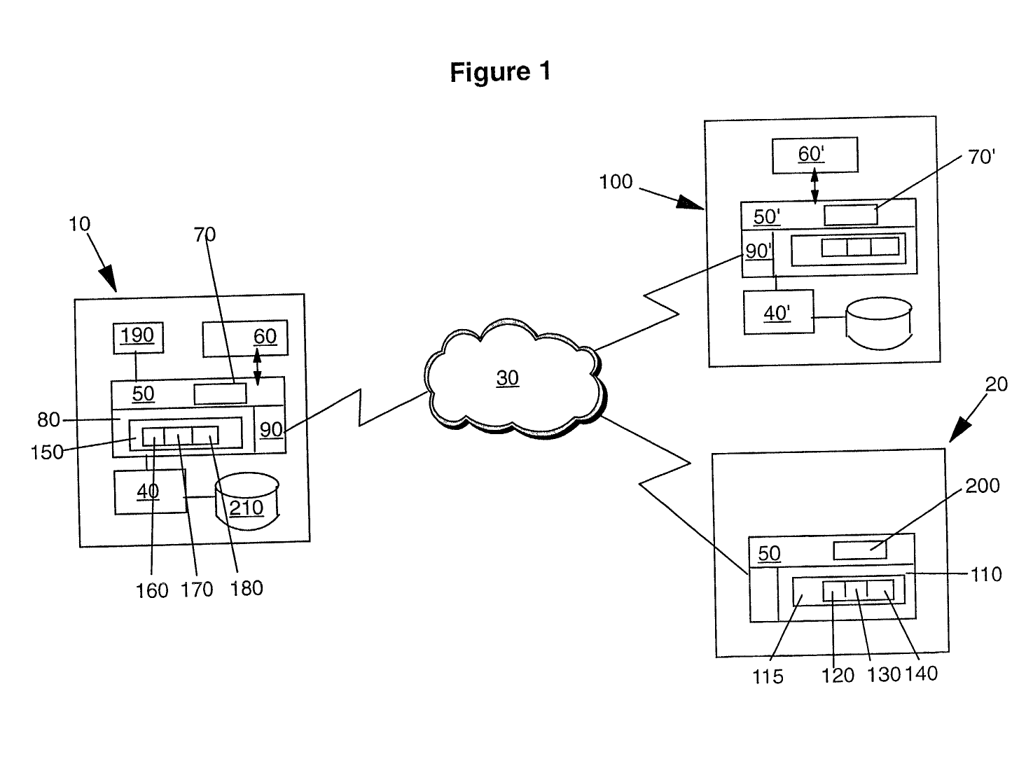

Referring to FIG. 1, the present invention is implementable in a first data processing apparatus 10 and a second data processing apparatus 20 which are connected via a data communication network 30. The first data processing apparatus 10 may be any data processing device or system, such as a desktop, laptop or palm-sized computing device, an interactive television set or a set-top box, a personal digital assistant (PDA), a mobile telephone, or an embedded processing device within a vehicle or within any other apparatus. The first data processing apparatus advantageously includes a processing unit, data storage means including volatile memory and secondary storage, internal communication buses and external communication connections, one or more input devices, and a display.

The invention is particularly applicable to mobile data processing devices since the problems inherent in maintaining security for data stored on such devices is more evident than for office-based apparatus. Additionally, the available data storage resources in mobile devices is typically more limited than in office-based computers, and so security schemes which partition data inefficiently are especially undesirable for mobile devices.

The second data processing apparatus may be any data processing device or system and hence the data communication network may be a heterogeneous network in which a plurality of different types of data processing apparatus are connected, such as for example the Internet or an intranet.

A number of computer programs are installed within the first data processing apparatus 10 of FIG. 1, including operating system software 40, a data access manager program 50 and one or more application programs 60. In a first embodiment of the invention, the data access manager 50 is a queue manager program which manages reliable communication of messages (and hence interoperation) between application programs across a heterogeneous network using asynchronous messaging and queueing.

The queue manager program 50 handles delivery of messages received from application programs 60 located on the same or other data processing apparatus across the network, saving received messages onto input message queues 80 for respective application programs and handling subsequent retrieval of the saved messages from an input queue for processing by a local application program 60 when the application program is ready. The queue manager also handles sending of messages from local application programs to remote applications on other data processing apparatus via an output queue (or ‘transmission queue’) and via a sender agent 90 (or ‘message channel agent’) on the local system cooperating with a receiver agent 90′ (‘message channel agent’) on the other system 100.

Message queuing and commercially available message queuing products are described in “Messaging and Queuing Using the MQI”, B. Blakeley, H. Harris & R. Lewis, McGraw-Hill, 1994, and in the following publications which are available from IBM Corporation: “An Introduction to Messaging and Queuing” (IBM Document number GC33-0805-00) and “MQSeries—Message Queue Interface Technical Reference” (IBM Document number SC33-0850-01). The network via which the computers communicate using message queuing may be the Internet, an intranet, or any computer or data communications network. IBM and MQSeries are trademarks of IBM Corporation.

IBM's MQSeries messaging software products provide transactional messaging support, synchronising messages within logical units of work in accordance with a messaging protocol which gives assured once and once-only message delivery even in the event of system or communications failures. MQSeries products provide assured delivery by not finally deleting a message from storage on a sender system until it is confirmed as safely stored by a receiver system, and by use of sophisticated recovery facilities. Prior to commitment of transfer of the message upon confirmation of successful storage, both the deletion of the message from storage at the sender system and insertion into storage at the receiver system are kept ‘in doubt’ and can be backed out atomically in the event of a failure. This message transmission protocol and the associated transactional concepts and recovery facilities are described in international patent application WO 95/10805 and U.S. Pat. No. 5,465,328, which are incorporated herein by reference.

The message queuing inter-program communication support provided by the MQSeries products enables each application program to send messages to the input queue of any other target application program and each target application can asynchronously take these messages from its input queue for processing. This provides assured delivery of messages between application programs which may be spread across a distributed heterogeneous computer network, but there can be great complexity in the map of possible interconnections between the application programs.

The present invention enables provision of additional data access control, including logging of data accesses and/or improved security, to enhance the message delivery mechanisms described above.

The queue manager program 50 according to the first embodiment of the present invention includes a decoding controller component 70. The structural and functional implementation of the decoding controller component will now be described in detail, with reference to the example of a requester application program 60 in use requesting access to a message which is held in the application program's input queue 80.

When an application program 60′ issues a “PutMessage” API call to send a message to a target queue 80 (for subsequent retrieval by a target application program 60), a queue manager 50′ on the sender system handles transmission of the message to the next node of the network which interconnects the sender and target systems. This includes the queue manager 50′ of the sender system 100 accessing a queue definition 110 for the target queue 80 to determine what security attributes are required. For example, each message queue's security attributes may be defined in a database such as a distributed LDAP directory accessible by all queue manager programs in the network. The database is stored on remote data processing apparatus 20. If the queue definition 110 for the target queue includes an identification of one or more of a specific cryptor 120 (for example, 3DES), compressor 130 (for example, run length encoding), or authenticator 140 (for example, SHA or MD5), then the sender queue manager 50′ applies the required encryption, compression or authentication before sending the message across the network.

As noted above, an application program 60 requests access to messages in its input queue via a queue manager program 50 on the local data processing apparatus 10. The application program issues a “GetMessage” API call and the queue manager identifies the next message in the queue. Assuming the message was encoded before transmission across the network, the application program cannot access the message data until a decoding process has been performed. The decoding cannot be performed under direct control of the application program because the application is not able to determine what encoding process or processes have been used. This is true even if the application program, or a user of the application program, already has a relevant decryption key.

A requester application's only mechanism for communication with the queue manager program 50 which implements the decoding controller 70 and which performs the decoding process is via API calls of a defined API (application programming interface—not shown). The API does not provide any way for application programs to access a queue's security attributes. From the perspective of an application, access to queue security attributes is performed invisibly via an underlying mechanism.

As well as not being visible to the application program or user, a full definition of the required decoding process or processes is not initially available on the local apparatus. The input message queue on the local data processing apparatus includes a class Attributes 150. The Attributes class encapsulates security attribute classes Cryptor 160, Compressor 170 and Authenticator 180. When, for the first time in the current session, a requester application program issues “GetMessage” to retrieve a message from a specific queue, the queue manager creates an instance of class Attributes, but at this time the characteristics of instances of classes Cryptor, Compressor and Authenticator are not fully defined on the local apparatus. The instances of the security attribute classes merely include references to a remote queue definition on a second data processing apparatus.

When “GetMessage” is issued, the decoding controller component 70 checks cache memory 190 of the local data processing apparatus 10 in case a complete definition of a relevant Cryptor, Compressor and Authenticator is already available on the local apparatus. As noted, if this is the first data access request in the current application program or user session, then a complete definition of queue and message attributes will typically not yet be available on the local apparatus (since security attributes are preferably not retained on the local apparatus between sessions). However, the invention is compatible with solutions in which a threshold security level is defined and in which certain message queues having a security level below the threshold have their security attributes fully defined on the local data processing apparatus without reliance on retrieval of remotely-stored attributes for a specific communication session. Nevertheless, the invention is used to provide a mechanism for sending requests to a second data processing system to determine attributes for message queues having a security level above such a threshold. If this is not the first data access request of the current application or user session, then the queue attributes may be in local cache memory.

Note that, in the above description, the security attributes are not being dynamically negotiated for each session—in this first embodiment of the invention predefined security attributes are being retrieved separately for each session. Nevertheless, the security attributes for an individual queue or the decoding keys could be changed periodically (for example every day) to reduce the window of opportunity for hackers to crack the encoding.

Note also that, although each message on a queue could potentially have different security attributes from other messages, security control at that level of granularity would typically be implemented by the application program rather than the queue managers. The first embodiment of the present invention implements security attributes at the queue level. Thus, a single definition (although possibly multiple replicas) of the queue attributes for each target queue is held in the database of queue definitions, and this is relevant to all messages sent to that queue.

When the queue manager 50 determines that a message for which “GetMessage” has been issued requires decoding and that the relevant decoding process attributes are not fully defined in the memory 190 of the local data processing apparatus, the decoding controller 70 of the queue manager establishes a communication channel with a second data processing apparatus 20 which holds the relevant queue definition 110 (e.g. holds a replica of at least a portion of the queue definition database). The decoding controller 70 requests from the second data processing apparatus a determination of the relevant security attributes for the queue. The queue definition includes a complete definition of the queue's security attributes. These attributes are retrieved from the memory of the second data processing apparatus by an access controller component 200 (for example, a database lookup program) which is running on the second data processing apparatus 20. The access controller component 200 logs the request for queue attributes and the attributes are returned to the decoding controller 70 on the first data processing apparatus. The attributes are received and saved in volatile memory 190 on the first data processing system 10.

Thus, prior to the communication with the second data processing apparatus 100, the local queue 80 contains the actual message data (for example, via a pointer to local disk storage 210), but the security attributes 160,170,180 for the local queue are not fully defined on the local data processing apparatus (the security attributes 160,170,180 are empty references to a remote queue definition 110 at this stage), whereas a remote data processing apparatus 20 holds a full security attributes definition 115 for the queue 80 and yet typically does not hold a copy of the queued messages.

Having received the attributes, the decoding controller 70 of the queue manager 50 on the first data processing apparatus 10 may be able to implement the decoding process, if the program code implementing the decoding is currently available on the first data processing apparatus. Note that in this first embodiment of the invention the security attributes of the queue definition are merely identifiers of encoding/decoding algorithms—the encoding/decoding program code is separate and may be permanently held on the first data processing apparatus or dynamically downloaded from a server when required. Also separate from the attributes are the decoder keys required for decryption or authentication which are securely exchanged between users or between interoperating application programs.

Upon receipt of the attributes, the decoding controller 70 checks whether the relevant program code for the identified decoding processes is currently available on the first data processing apparatus (“locally” available), and if not it initiates downloading of the required program code from a code library on the second data processing apparatus 20 or another data processing apparatus.

Having found the decoding program code locally or downloaded it, the decoding controller is now able to use this code to perform the decoding processes. When the current user session or application program session is ended, the retrieved security attributes are deleted from volatile memory 190 of the first data processing apparatus 10 such that no record of the security attributes is kept on the first data processing apparatus. Since the attributes are deleted from volatile memory 190 and are never transferred to non-volatile disk storage 210 of the first data processing system, the network communication has to be repeated for each session, enabling per-session tracking of data accesses and ensuring that any security controls such as authentication checking or decryption can be enforced for each session and cannot be bypassed by merely referring to locally saved information.

Advantageously, the first step of using the decoding processes entails performing user authentication using an authenticator identified by the retrieved attributes. Alternatively, user authentication could be implemented earlier, either authenticating the user as an authorised user of the first data processing apparatus before a request can be sent to the second data processing apparatus, or authenticating on the second data processing apparatus before the access controller on the second data processing apparatus will provide the requested attributes. A next step entails decrypting encrypted messages, and then a further step entails decompressing compressed data.

Thus, the invention enables security controls which are compatible with the remote access control feature to be implemented in a number of different ways. The invention may be implemented in combination with known security features.

In alternative implementations of the invention, the actual program code implementing decryption, decompression, and authentication may be stored as attributes in the queue definition database, instead of only storing identifiers as attributes. Decoding keys, particularly public keys, could equally be attributes stored in the queue definition database.

Embodiments of the invention have been described above in the context of controlling access to data which has been sent across a network using message queuing. The invention may equally be implemented to control access to data which was not transmitted across the network but was stored on the data processing apparatus outside of the scope of the current user or application session in response to data entry by a user or from a diskette or CD-ROM. In this context, the invention has the same advantages of controlling access to locally held data for auditing or improved security.

Thus, the present invention provides a mechanism for controlling a local user or application's access to data stored (for example in a queue) on a client device, as distinct from the typical control at a server computer of access to data which is held on the server. The characteristics of processes which are required for decoding data on the client system are not fully defined on the client device until a communication with the server is performed, and even then the complete process definitions are preferably not visible to the requesting application and are only fully defined on the client device for the current requestor session, such that the data is inaccessible when the client device is offline and the server computer is able to control and to log access to the data stored on the client device even if the server does not hold a copy of that data.

In particular implementations of the invention, processes on the first data processing apparatus and on a sender data processing apparatus which originates a message transmission may both be required to fully define security attributes for data encoding and subsequent data access. For example, instead of merely identifying and using predetermined encoding and decoding processes, there may be a negotiation of which cryptor is to be used with reference to rules about permitted cryptographic strength, as described in UK patent application GB9907307.4 (IBM reference UK999021) which is incorporated herein by reference. Additionally, there may be a negotiation of attributes such as a cryptor, a compressor or other quality of service attributes with reference to the capabilities of the sending and receiving systems.

In the example implementations described above, the operating system software 40 and data access manager 50 were described as separate components. In alternative implementations, the data access manager and operating system may be implemented as a single computer program. Thus, the data access manager function may be just one aspect of the function of a software product implementing the invention.

What is claimed is:

1. A method of controlling access to data, comprising:
in response to a request from a requester for access to data stored in an encoded form on a first data processing apparatus, sending a request from a decoding controller on the first data processing apparatus to a second data processing apparatus to determine attributes of a decoding process for accessing the encoded data;
in response to said request to the second data processing apparatus, receiving said determined attributes at said decoding controller;
performing the decoding process in accordance with the determined attributes.

2. A method according to claim 1, wherein the requester communicates via an application programming interface with a data access manager which includes the decoding controller, the application programming interface being predefined such that the decoding controller and any received decoding attributes are shielded from the requester.

3. A method according to claim 1, wherein received attributes are stored in volatile memory of the first data processing apparatus when received, and are deleted from said memory at the end of a current requester session, such that a request to determine attributes of a decoding process must be repeated for each requester session for which access to encoded data is required.

4. A method according to claim 1, wherein the determined attributes of a decoding process include identifiers of one or more of: a cryptor used in encryption and required for decryption; a compressor used in compression and required for decompression; and an authenticator for requestor authentication.

5. A method according to claim 4, including the steps, subsequent to receiving said determined attributes, of:
checking whether program code implementing said identified cryptor, compressor and authenticator is stored on the first data processing apparatus; and, if not, initiating downloading of the respective program code from the second data processing apparatus or another data processing apparatus.

6. A method according to claim 1, wherein the determined attributes of a decoding process include program code implementing the decoding process.

7. A method according to claim 1, wherein the attributes of a decoding process include one or more decoding keys for use in decryption or authentication.

8. A method according to claim 1, including logging at the second data processing apparatus said requests to determine attributes.

9. A method according to claim 1, including authenticating the requester to the second data processing apparatus before determining the attributes of the decoding process.

10. A computer program product comprising machine-readable recording medium having recorded thereon computer program code implementing functions for controlling the operation of a data processing apparatus on which the program code runs to perform the following steps of a method for controlling access to encoded data:
in response to a request from a requester for access to data stored in an encoded form on a first data processing apparatus, sending a request from a decoding controller on the first data processing apparatus to a second data processing apparatus to determine attributes of a decoding process for accessing the encoded data;
in response to said request to the second data processing apparatus, receiving said determined attributes at said decoding controller;
performing the decoding process in accordance with the determined attributes.

11. A first data processing apparatus including:
a processing unit;
data storage means;
communication means for sending and receiving communications from data processing systems connectable to said first data processing apparatus via a network; and
a decoding controller, responsive to a request from a requestor for access to data stored in an encoded form in said data storage means, for sending a request via said communication means to a second data processing apparatus to determine attributes of a decoding process for accessing the encoded data and for receiving said determined attributes via said communication means;
wherein the decoding controller is adapted to control the operation of the processing unit to perform the decoding process in accordance with the determined attributes.

12. A data processing apparatus, including:
a processing unit;
data storage means storing attributes of one or more decoding processes, which processes are associated with specific data stored in an encoded form on the data processing apparatus; and
an access controller component, for retrieving the stored attributes from the memory in response to a request from a remote data processing apparatus, and for sending the retrieved attributes to the data processing apparatus.

13. A data processing apparatus according to claim 12, including means for logging said requests to determine attributes.

14. A data processing apparatus according to claim 12, including means for authenticating the requestor before retrieving the stored attributes of a decoding process.
